(19) United States
(12) Patent Application Publication
(10) Pub. No.: US 2014/0129279 A1
(43) Pub. Date: May 8, 2014

(54) METHODS AND APPARATUS FOR SCHEDULE MANAGEMENT

(71) Applicant: INTERNATIONAL BUSINESS MACHINES CORPORATION, Armonk, NY (US)

(72) Inventors: Maharaj Mukherjee, Hopewell Junction, NY (US); Monimala Mukherjee, Hopewell Junction, NY (US)

(73) Assignee: International Business Machines Corporation, Armonk, NY (US)

(21) Appl. No.: 13/690,727

(22) Filed: Nov. 30, 2012

Related U.S. Application Data
(63) Continuation of application No. 13/667,570, filed on Nov. 2, 2012.

(51) Int. Cl. G06Q 10/10

(52) U.S. Cl. CPC G06Q 10/1095
USPC 705/7.19

(57) ABSTRACT

Systems and techniques for schedule management are described. Previously scheduled and proposed events for a user are examined to determine if multiple events occupy the same time period, and the presence of such multiple events is identified as a conflict affecting the time period. A severity value is determined for each time period affected by such multiple events, with the determination suitably employing a recursive function based at least in part on a number of conflicting events and their severities. Conflict and conflict severity information may be presented to users in the form of a display indicating relative severities of conflicts, or alerts having characteristics based at least in part on conflict severity.

### FIELD OF THE INVENTION

One or more embodiments of the present invention relate generally to systems and techniques for schedule management. More particularly, the invention relates to improved mechanisms for recognizing the severity of scheduling conflicts and informing users of such severity.

### BACKGROUND

Many persons schedule and manage their activities using electronic data management devices, such as desktop and notebook computers hosting calendar and scheduling software, portable devices, such as portable data organizers and cellular telephones including smartphones, and cloud services, which store user calendar and scheduling information in a central repository accessible to many device that may be employed by a user. User schedule information is generally stored and managed in the form of a calendar, with a number of time periods predefined for each date, with the user being able to define time periods within each date, or both. A user's schedule information may be available to others to a greater or lesser extent. For example, a user's assistant may have a similar level of access to the user's schedule information as does the user. A more restricted form of access may be provided to others who do not participate in managing the user's schedule. For example, users who wish to schedule events with a user, such as inviting a user to meetings, may be able to see whether or not the user has events scheduled at a particular time, even if they cannot see what those events are.

Calendar and schedule management mechanisms typically allow a user to schedule multiple events at the same time, and may also allow other users to issue invitations, even when the user receiving the invitation already has other events scheduled for the time for which the invitation is issued. Users typically wish to control their schedules and do not wish for scheduling software and devices to prevent them from scheduling multiple simultaneous events, because the absolute blocking of scheduling conflicts deprives users of the ability to sort through their schedules themselves and decide which events should remain on the schedule and which should be removed. Scheduling mechanisms typically notify users of scheduling conflicts, leaving it to the users to sort out the conflicts.

### SUMMARY

In one embodiment of the invention, a method comprises configuring at least one processor to cause an apparatus to at least analyze stored schedule information representing scheduled events for at least one identified party, determine if at least two events for the at least one identified party are scheduled for a single time period and, if at least two events for the identified party are scheduled for the single time period, determine a severity value for a conflict affecting the single time period.

In another embodiment of the invention, a method comprises assembling schedule information for at least one identified party, wherein the schedule information comprises information relating to conflict information for events proposed for overlapping time periods, wherein the conflict information comprises information relating to severity of a conflict for each time period, associating schedule information for each identified party with severity value indicia for each time period, with the indicia indicating a severity value for a conflict affecting the time period, and organizing the schedule information for presentation, wherein presentation is based at least in part on the indicia for each time period.

In another embodiment of the invention, an apparatus comprises at least one processor and memory storing computer program code. The memory storing the computer program code is configured to, with the at least one processor, cause the apparatus to at least analyze stored schedule information representing scheduled events for at least one identified party, determine if at least two events for the at least one identified party are scheduled for a single time period and, if at least two events for the identified party are scheduled for the single time period, determine a severity value for a conflict affecting the single time period.

In another embodiment of the invention, an apparatus comprises at least one processor and memory storing computer program code. The memory storing the computer program code is configured to, with the at least one processor, cause the apparatus to at least assemble schedule information for at least one identified party, wherein the schedule information comprises information relating to conflict information for events proposed for overlapping time periods, wherein the conflict information comprises information relating to severity of a conflict for each time period, associate schedule information for each identified party with severity value indicia for each time period, with the indicia indicating a severity value for a conflict affecting the time period, and organize the schedule information for presentation, wherein presentation is based at least in part on the indicia for each time period.

In another embodiment of the invention, a computer readable medium stores a program of instructions. Execution of the program of instructions by a processor configures an apparatus to at least analyze stored schedule information representing scheduled events for at least one identified party, determine if at least two events for the at least one identified party are scheduled for a single time period and, if at least two events for the identified party are scheduled for the single time period, determine a severity value for a conflict affecting the single time period.

In another embodiment of the invention, a computer readable medium stores a program of instructions. Execution of the program of instructions by a processor configures an apparatus to at least assemble schedule information for at least one identified party, wherein the schedule information comprises information relating to conflict information for events proposed for overlapping time periods, wherein the conflict information comprises information relating to severity of a conflict for each time period, associate schedule information for each identified party with severity value indicia for each time period, with the indicia indicating a severity value for a conflict affecting the time period, and organize the schedule information for presentation, wherein presentation is based at least in part on the indicia for each time period.

### BRIEF DESCRIPTION OF THE SEVERAL VIEWS OF THE DRAWINGS

FIG. 1 illustrates a system according to an embodiment of the present invention;

FIG. 2 illustrates a process according to an embodiment of the present invention;

FIG. 3 illustrates an example of a user interface according to an embodiment of the present invention; and

FIG. 4 illustrates elements that may be used for carrying out embodiments of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention recognize that modern users have numerous demands on their time, with solicitations from others, and enticements for a user to schedule events constantly pouring in. Users may typically wish to allow conflicting schedule entries, but they would also welcome mechanisms to reduce the time they need to spend managing scheduling conflicts. Embodiments of the present invention also recognize that different events may have different levels of importance, and that these levels of importance may vary depending on a user's particular preferences.

In one or more embodiments of the invention, therefore, analysis of a scheduling conflict is undertaken to evaluate the severity of a conflict. The analysis takes into account the importance of scheduled events and proposed events, the number of proposed events, the availability alternative times for proposed events, preferences of the user, and other relevant information. In one or more embodiments of the invention, a conflict may be determined to have a high severity if two or more of the conflicting events have a relatively high importance so that a more careful consideration is needed to determine which one is to be given the specified time period and which one is to be removed from the schedule or moved to a different time. In such embodiments, a conflict may be determined to have a lower severity if the scheduled event and the proposed events all have a relatively low importance, or if one of the events has a significantly higher importance than the others. If the events that are to be discarded or moved are all relatively unimportant, removal or rescheduling of events can be performed automatically if the scheduling mechanisms being used are so configured. If removal or rescheduling must be done by a user, the process can still be expected to be relatively simple because removal of unimportant events need not be given particularly careful consideration. If a scheduled event is of significantly higher importance than any proposed event, a conflict may be determined to have a low severity, because the proposed events can simply be automatically rejected or it may be expected that the proposed events will be rejected.

Other factors tending to lead to the determination that a conflict has a low severity include the availability of adjacent time periods, particularly in cases in which timing for proposed events is flexible. For example, a proposed event may be scheduled to an adjacent time period and a notification may be sent to a party proposing the event.

In one or more alternative embodiments of the invention, a proposed event, such as an invitation from another user or a scheduling entry by the user, is evaluated based on its impact on the schedule of the receiving user. Severity may, for example, take into account the importance of previously scheduled events for the receiving user, the existence and number of other proposed events for the receiving user, and the flexibility of timing for the scheduled event, for the event being proposed, and for the other proposed events. Determinations of flexibility for a scheduled event and for other proposed events may take into account the number of others involved in the events. For example, the more attendees have been invited to a meeting, the more difficult it will be to readjust the time of the meeting, and the more severe will be a schedule conflict relating to the meeting, whether the meeting has already been scheduled for a user, or an invitation to the meeting is presented to the user as a proposed event.

If information is shared between a user receiving a proposed event and a user proposing the event, conflict severity information can be provided to users proposing events. For example, suppose that a user is proposing a meeting. If the meeting presents minor conflicts for a few invitees, or even minor conflicts for many invitees, a meeting host may expect a reasonably good attendance. However, if the meeting presents severe conflicts for many invitees or for a particularly important invitee, the meeting host may be more likely to reschedule the meeting. If information relating to user schedule information is freely available, such as between employees of an organization, conflict information may be evaluated for a proposed meeting or other event without a need to actually issue invitations. The time for the event can then be chosen so as to minimize the overall severity of conflicts presented by the event.

Once the presence and severity of a conflict or conflicts are determined, information relating to conflicts can be presented to users in easy to understand ways, and mechanisms for alerting users to the presence of conflicts. For example, the state of a user's schedule with respect to conflicts can be identified by color coding or gray coding, and alerts to incoming or newly entered proposed events that represent conflicts can be provided by mechanisms such as sound or vibration.

One or more embodiments of the invention implement a severity function. The severity function may be a recursively defined function depending on a severity value associated with each event in a requested time period, and additionally based in part on preferences and parameters associated with the user. The preferences and parameters may depend on event priorities set by a user. For example, a user may assign a higher priority to events proposed by members of his or her work team and a lower priority to events such as sales meetings with outside vendors. The preferences and parameters may also depend on user choices relating to conditions that do not relate directly to event priorities, such as a desire to have a gap between meetings or a desire not to schedule meetings in the last hour of the day.

An exemplary severity function may be as follows:

S(tᵢ,Eⱼ)=F(S(tᵢ,Eₖ), where k=1, 2, . . . , Pₘ, m=1, 2, . . . ), where:

S(tᵢ, Eⱼ) is the severity of the event Eⱼ for time period tᵢ, and is based on the severity of other proposed events at the same time period t, for a multiply competing proposed event Eₖ).

Pₘ defines user preferences.

S(tᵢ, Eⱼ) is a monotonically increasing function that depends on the number of conflicts and the severities of the conflicting events, as well as on the priorities. As the user's schedule is adjusted, that is, as proposed events Eₖ are added to and removed from the user's schedule for the particular time period, the severity value S(tᵢ, Eⱼ) will update, and changes to the parameters Pₘ will also cause changes to the severity value.

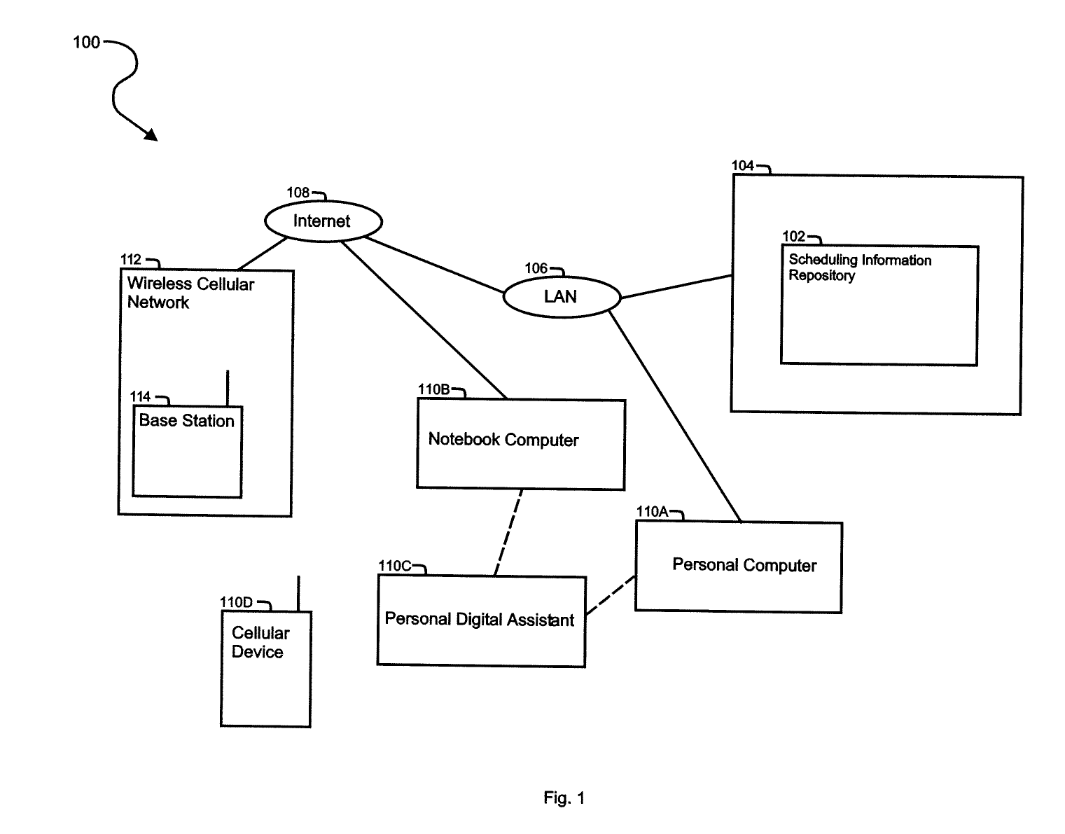

FIG. 1 illustrates a system 100 according to an embodiment of the present invention. The system 100 may be implemented by an organization and may comprise a central repository 102 storing scheduling information for members or employees of the organization. The repository 102 may be hosted by a server 104, accessible through a local area network (LAN) 106, which may in turn provide access to the public Internet 108. Members of the organization may gain access to the repository 102 through devices such as the exemplary devices 110A-110D, presented here by way of example as a personal computer 110A, a notebook computer 110B, a personal digital assistant 110C that may conveniently receive information through connection with either of the personal computer 110A and the notebook computer 110B, and a wireless cellular device 110D, which may be a smartphone. Any of a wide variety of other suitable devices may be used. The devices 110A-110D and other devices may gain access to the repository 102 through the LNA 106, the Internet 108, direct connection to the server 104, or any other mechanism desired. The wireless cellular device 110D and similar devices may gain access to data services, such as access to the Internet 108, through a wireless network 112 comprising a base station 114. It will be recognized that the configuration of the system 100 as providing a central repository as exemplary, and that scheduling information may be stored separately on each user's device or devices, or may be separately stored for some users and centrally stored for others. Numerous other alternative or additional embodiments may be employed.

In one or more embodiments of the invention, the repository 102 may comprise a scheduling information database 116, which may store scheduling information for each user, and may comprise information both for the user's own schedule and information for events proposed by the user. In one exemplary embodiment, proposed events may be meeting invitations, and meeting invitations may be directed from one user to another, and evaluated by the sending user and the receiving user in terms of their impact on the schedule of the receiving user. The evaluation may be performed in terms of a severity function similar to that described above.

In many commonly encountered implementations, a user's schedule is divided into days, and each day is divided into time periods of 30 minutes each. Events are scheduled to occupy particular time periods, and the severity of a conflict presented by a proposed event may be determined with respect to each time period The particular treatment of the timespan for a scheduled event presenting a conflict over one or more time periods may be managed as desired. For example, the entire timespan may be designated as affected by a conflict having the severity associated with the most severely affected time period, or the severity of the conflicts over the time periods making up the timespan may be averaged over the timespan. To take another example, the severity of the conflict may be reduced if only one time period is affected by a severe conflict, the severity may be diminished if the affected time period appears at or near the end of the timespan. Numerous different configurations are possible, and may be set according to user preferences.

Numerous configurations for presentation of information may also be implemented, and these configurations can vary depending on the immediate needs of a particular user. For example, in the case of a meeting organizer, conflict information can be presented with respect to the meeting, showing the time periods over which the meeting extends and showing conflict and severity information for all meeting invitees. Conflict information relating to the meeting can also be incorporated into a presentation of the daily schedule of each of the meeting invitees, because the overall schedule is what interests the meeting invitees, rather than one particular scheduled event.

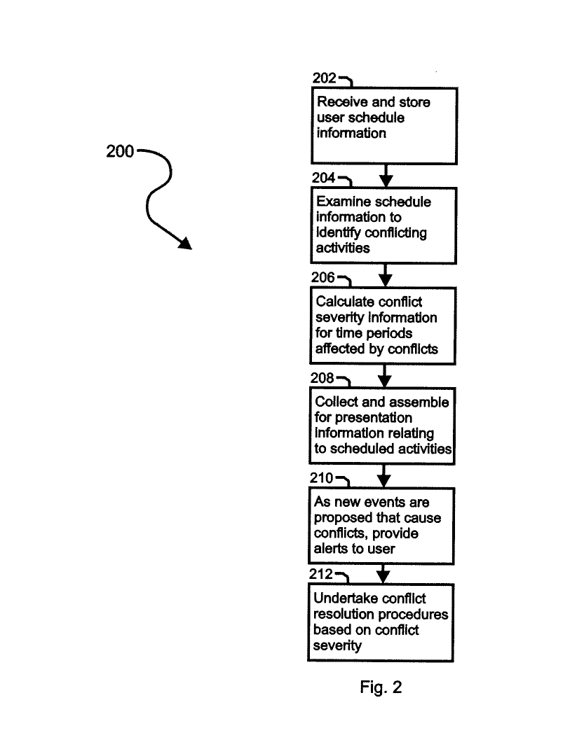

FIG. 2 illustrates a process 200 according to an embodiment of the present invention. At step 202, information relating to a user's scheduled events is received and stored. At step 204, the information is examined to determine if multiple events are scheduled for the same time, and at step 206, conflict severity information is calculated for time periods for which multiple events are scheduled. In one or more embodiments of the invention, each user's schedule is organized into multiple time periods and a severity value is calculated for each time period. Step 206 is repeated as the user's schedule is updated—as new events are proposed, as scheduled events are deleted, and as time passes and future events become past events.

At step 208, information relating to a user's scheduled events is collected and assembled as needed, with conflict information and conflict severity information being presented to users having a need for the information. To take one example, a user's weekly schedule information may be presented in terms of a grid, with each day's scheduled events occupying a column. Each column may be divided into time periods, and each time period may be presented in a manner reflecting the severity of the conflict. For example, a time period may be color coded or may include an icon reflecting the severity of the conflict. Depending on system configuration, user preferences, and other factors, severity information may be presented separately for each time period, or multiple time periods may be presented with severity information associated with an event or proposed event spanning several time periods. For example, if an important event spans several time periods, each time period during which the event is scheduled may be depicted as affected by a severe conflict.

To take another example, information may be presented to an organizer of an event in terms of users to which the event is being proposed, such as in the case of a meeting organizer and meeting attendees. For example, a schedule grid may be presented showing the time periods during which the meeting is to take place and the invitees to the meeting, with conflict and conflict severity information being presented for each attendee. The conflict severity information may be presented as color coding, and the meeting organizer may, if he or she has sufficient authorization, examine schedule information for one or more users to identify the conflicting events. Thus, conflict severity information for the user being presented here may be presented as part of an overall display to a meeting organizer proposing an event for the user.

At step 210, as new events are proposed for a user and determined to cause a conflict, alerts may be provided to the user to indicate the presence of the conflict. For example, a user's portable device may be made to vibrate, an alert signal may be sounded, or an alert icon may be presented on a user's schedule display.

At step 212, conflict resolution procedures are undertaken based on conflict severity. For example, events that are known to be minor may be removed if they conflict with important events, or may be rescheduled to adjacent times. Conflicts determined to be severe because, for example, they involve important conflicting events may be addressed by relaying appropriate messages to the user proposing the event and the user for which the event is proposed, so that they may examine and resolve the conflicts.

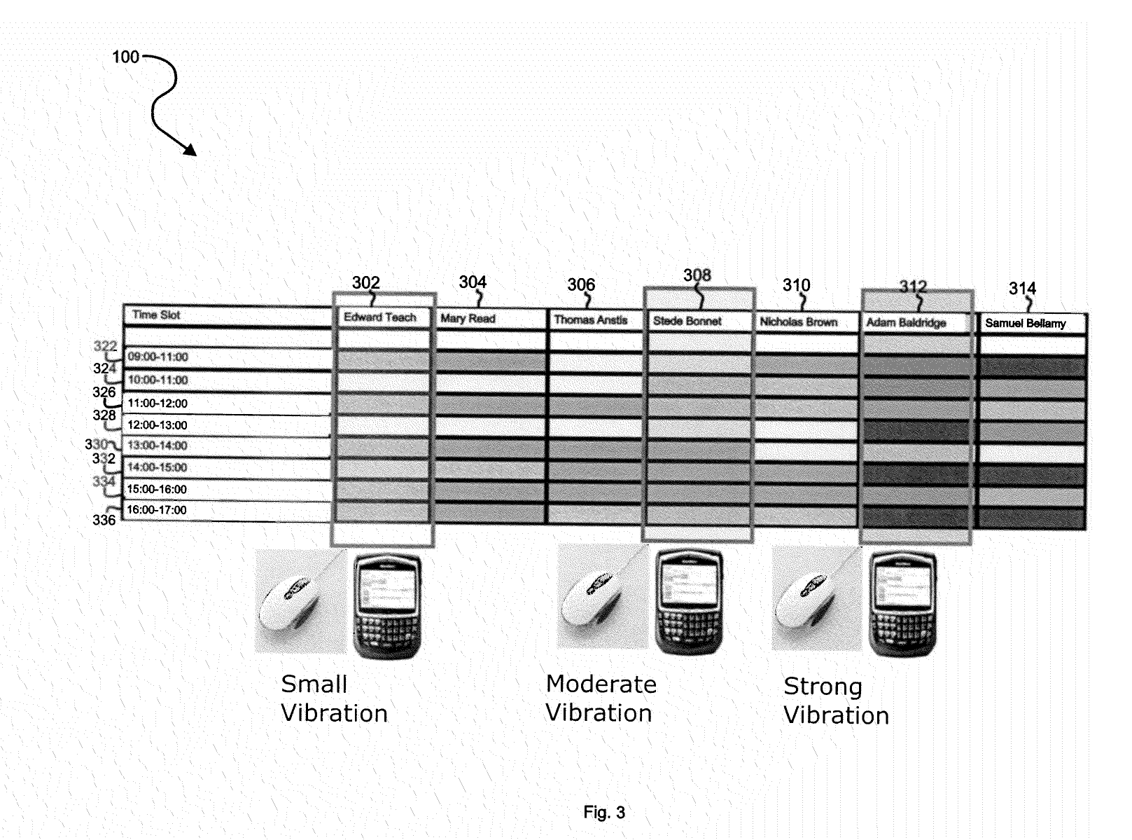

FIG. 3 illustrates an exemplary information display 300 presenting conflict and conflict severity information for a meeting with multiple invitees. The meeting schedule is organized into columns 302-314, representing invitees, and rows 322-336, representing time periods, with a cell at each intersection of a column and a row and a color code is present in each cell indicating the absence of a conflict, or the severity of a conflict if one is present. FIG. 3 also presents devices belonging to selected users, which can be triggered to alert based on the severity of a conflict. For example, the user Edward Teach has few conflicting events, and those conflicting events are of low severity, so that an alert may comprise, for example, a small vibration. the user Stede Bonnet has more conflicting events, some of which are of greater severity, and an alert may comprise a larger vibration, and the user Adam Baldridge has still more conflicting events, a number of which are of even greater severity, so that an alert may comprise a strong vibration.

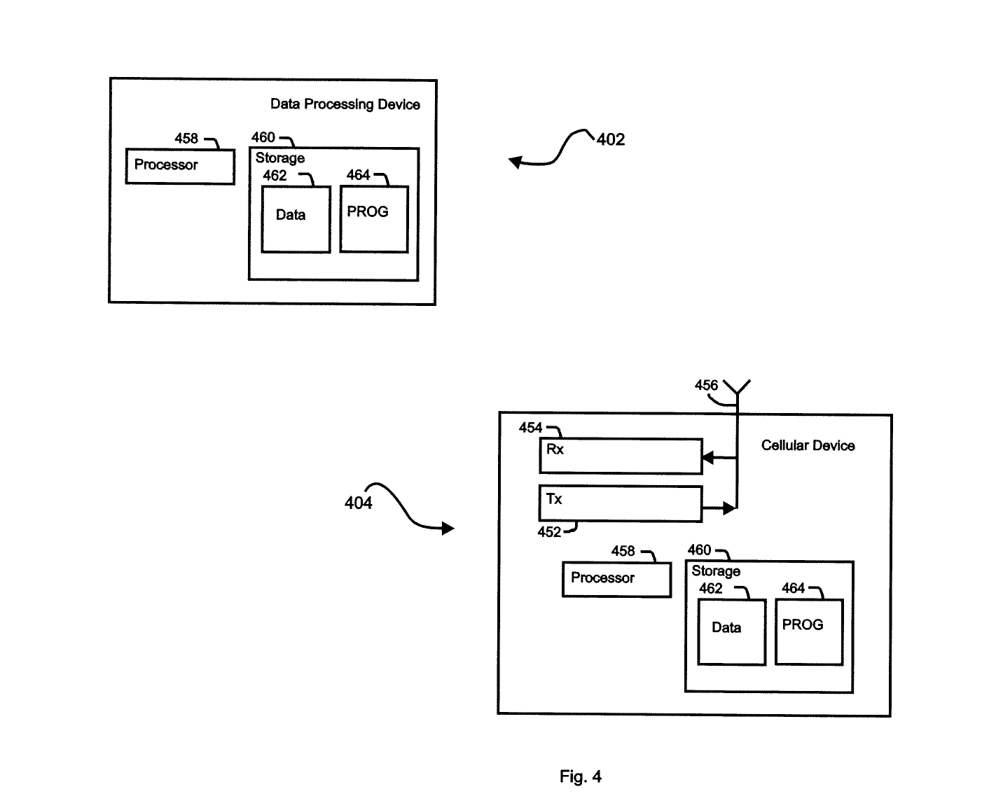

Reference is now made to FIG. 4 for illustrating a simplified block diagram of details of electronic devices including a data processing device 400, which may include elements similar to the server 104, as well as a cellular communication and data processing device 404, which may include elements similar to those of the cellular device 110D of FIG. 1.

The data processing device 402 includes a data processor (DP) 406, and a memory (MEM) 408 that stores data 410 and one or more programs (PROG) 412. The cellular communication device 404 includes a transmitter 452, receiver 454, antenna 456, DP 458, and MEM 460 that stores data 462 and one or more programs (PROG) 464.

At least one of the PROGs 412 and 464 is assumed to include program instructions that, when executed by the associated DP, enable the electronic device to operate in accordance with the exemplary embodiments of this invention as was detailed above in detail.

In general, the exemplary embodiments of this invention may be implemented by computer software executable by the DPs 406 and 458, or by hardware, or by a combination of software and/or firmware and hardware. The interactions between the major logical elements should be obvious to those skilled in the art for the level of detail needed to gain an understanding of the broader aspects of the invention beyond only the specific examples herein. It should be noted that the invention may be implemented with an application specific integrated circuit ASIC, a field programmable gated array FPGA, a digital signal processor or other suitable processor to carry out the intended function of the invention, including a central processor, a random access memory RAM, read only memory ROM, and communication ports for communicating between the various devices.

In general, the various embodiments of the cellular device 404 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 408 and 460 may be of any type suitable to the local technical environment and may be implemented using any suitable data storage technology, such as semiconductor based memory devices, magnetic memory devices and systems, optical memory devices and systems, fixed memory and removable memory. The DPs 406 and 458 may be of any type suitable to the local technical environment, and may include one or more of general purpose computers, special purpose computers, microprocessors, digital signal processors (DSPs) and processors based on a multi-core processor architecture, as non-limiting examples.

At least one of the memories is assumed to tangibly embody software program instructions that, when executed by the associated processor, enable the electronic device to operate in accordance with the exemplary embodiments of this invention, as detailed by example above. As such, the exemplary embodiments of this invention may be implemented at least in part by computer software executable by the DP 406 of the data processing device 402, the DP 458 of the cellular device 404, or by hardware, or by a combination of software and hardware.

Various embodiments of the present invention provide for an improved quality of scheduling information by furnishing users with the information that conflicts exist and information about the severity of those conflicts, allowing them information that can be used to determine what steps, if any, should be taken to resolve the conflicts and providing automated conflict resolution mechanisms with information that can be used to identify conflicts most appropriate for resolution.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1-16. (canceled)

17. An apparatus comprising:
at least one processor;
memory storing computer program code:
wherein the memory storing the computer program code is configured to, with the at least one processor, cause the apparatus to at least:
analyze stored schedule information representing scheduled events for at least one identified party;
determine if at least two events for the at least one identified party are scheduled to overlap during a single time period; and
if at least two events for the identified party are scheduled to overlap during the single time period, determine a severity value for a conflict affecting the single time period, wherein determining the severity value for the conflict takes into account the availability of time for rescheduling one or more of the at least two events.

18. The apparatus of claim 17, wherein determining a severity value comprises computing a severity value for at least one of the at least two conflicting events scheduled to overlap during the time period, wherein the severity value for the scheduled event is based at least in part on a severity value for at least one competing event.

19. The apparatus of claim 18, wherein the severity value is determined based at least in part on a number of conflicting events, a severity value for each conflicting event, and a priority value associated with each event.

20. The apparatus of claim 19, wherein the severity value is a monotonically increasing function computed based on one or more of the priorities of events, the number of conflicts, and the severities of conflicts.

21. The apparatus of claim 19, wherein the severity value is computed as S(tᵢ, Eⱼ)=F(S(tᵢ, Eₖ), wherein k=1, 2, . . . , Pₘ, m=1, 2 wherein S(tᵢ, Eⱼ) is the severity of the event Eⱼ for time period tᵢ, wherein S(tᵢ, Eⱼ) is based on the severity of other proposed events at the same time period tᵢ for a multiply competing proposed event Eₖ), wherein Pₘ defines user preferences, and wherein S(tᵢ, Eⱼ) is a monotonically increasing function that depends on the number of conflicts and the severities and priorities of the conflicting events.

22. The apparatus of claim 17, wherein the memory storing the computer program code is further configured with the at least one processor, to cause the apparatus to determine, for each of a plurality of time periods, whether the time period is affected by at least one conflict and assembling information for one or more time periods of the plurality of time periods, wherein the information for the one or more time periods comprises conflict information for the respective time period.

23. The apparatus of claim 17, wherein the memory storing the computer program code is further configured with the at least one processor, to cause the apparatus to present the information for the one or more time periods of the plurality of time periods over a user interface.

24. The apparatus of claim 17, wherein presenting the presenting the information for the one or more time periods of the plurality of time periods comprises presenting schedule information for multiple identified parties with respect to a common event proposed for the multiple identified parties.

25. An apparatus comprising:
at least one processor;
memory storing computer program code:
wherein the memory storing the computer program code is configured to, with the at least one processor, cause the apparatus to at least:
assemble schedule information for at least one identified party, wherein the schedule information comprises information relating to conflict information for events proposed for overlapping time periods, wherein the conflict information comprises information relating to severity of a conflict for each time period, wherein determining the severity value for the conflict takes into account the availability of time for rescheduling one or more of the at least two events;
associate the schedule information for each identified party with severity value indicia for each time period, with the indicia indicating a severity value for a conflict affecting the time period; and
organize the schedule information for at least one identified party for presentation, wherein presentation is based at least in part on the indicia for each time period.

26. The apparatus of claim 25, wherein the presentation of each time period is based on individually determined severity value indicia.

27. The apparatus of claim 25, wherein severity value information for an event spanning multiple time periods is taken into account in determining whether to present severity value indicia for time periods spanned by the event.

28. The apparatus of claim 25, wherein presentation of schedule information is performed with respect to a single identified party.

29. The apparatus of claim 25, wherein presentation of schedule information is performed for an event proposed for multiple parties and indicates conflict information indicating conflict severity for each party for whom the event is proposed, over a timespan proposed for the event.

30. The apparatus of claim 25, wherein presentation of schedule information comprises issuing an alert indicating the presence of a conflict, wherein the alert includes at least one characteristic indicating the severity of the conflict.

31. The apparatus of claim 30, wherein the alert is directed to a party in whose schedule information the conflict appears.

32. The apparatus of claim 30, wherein the alert is directed to a party proposing an event affected by the conflict.

33. A computer readable medium comprising:
a non-transitory computer readable medium storing a program of instructions, execution of which by a processor configures an apparatus to at least:
analyze stored schedule information representing scheduled events for at least one identified party;
determine if at least two events for the at least one identified party are scheduled to overlap during a single time period; and
if at least two events for the identified party are scheduled to overlap during the single time period, determine a severity value for a conflict affecting the single time period, wherein determining the severity value for the conflict takes into account the availability of time for rescheduling one or more of the at least two events.

34. The non-transitory computer readable medium of claim 33, wherein determining the severity value comprises computing a severity value for at least one of the at least two conflicting events scheduled to overlap during the time period, wherein the severity value for the scheduled event is based at least in part on a severity value for at least one competing event.

35. The non-transitory computer readable medium of claim 34, wherein the severity value is determined based at least in part on a number of conflicting events, a severity value for each conflicting event, and a priority value associated with each event.

36. The non-transitory computer readable medium of claim 35, wherein the severity value is a monotonically increasing function computed based on one or more of the priorities of events, the number of conflicts, and the severities of conflicts.

37. The non-transitory computer readable medium of claim 35, wherein the severity value is based at least in part on at least one user preference.

38. The non-transitory computer readable medium of claim 33, wherein execution of the program of instructions by the processor further configures the apparatus to determine, for each of a plurality of time periods, whether the time period is affected by at least one conflict and assembling information for one or more time periods of the plurality of time periods, wherein the information for the one or more time periods comprises conflict information for the respective time period.

39. The non-transitory computer readable medium of claim 33, wherein execution of the program of instructions by the processor further configures the apparatus to present the information for the one or more time periods of the plurality of time periods over a user interface.

40. The non-transitory computer readable medium of claim 33, wherein presenting the presenting the information for the one or more time periods of the plurality of time periods comprises presenting schedule information for multiple identified parties with respect to a common event proposed for the multiple identified parties.

41. A non-transitory computer readable medium comprising a program of instructions, execution of which by a processor configures an apparatus to at least:
assemble schedule information for at least one identified party, wherein the schedule information comprises information relating to conflict information for events proposed for overlapping time periods, wherein the conflict information comprises information relating to severity of a conflict for each time period;
associate the schedule information for each identified party with severity value indicia for each time period, with the indicia indicating a severity value for a conflict affecting the time period, wherein determining the severity value for the conflict takes into account the availability of time for rescheduling one or more of the at least two events; and
organize the schedule information for at least one identified party for presentation, wherein presentation is based at least in part on the indicia for each time period.

42. The non-transitory computer readable medium of claim 41, wherein the presentation of each time period is based on individually determined severity value indicia.

43. The non-transitory computer readable medium of claim 41, wherein severity value information for an event spanning multiple time periods is taken into account in determining whether to present severity value indicia for time periods spanned by the event.

44. The computer readable medium of claim 41, wherein presentation of schedule information is performed with respect to a single identified party.

45. The non-transitory computer readable medium of claim 41, wherein presentation of schedule information is performed for an event proposed for multiple parties and indicates conflict information indicating conflict severity for each party for whom the event is proposed, over a timespan proposed for the event.

46. The non-transitory computer readable medium of claim 41, wherein presentation of schedule information comprises issuing an alert indicating the presence of a conflict, wherein the alert includes at least one characteristic indicating the severity of the conflict.

47. The non-transitory computer readable medium of claim 46, wherein the alert is directed to a party in whose schedule information the conflict appears.

48. The non-transitory computer readable medium of claim 46, wherein the alert is directed to a party proposing an event affected by the conflict.
